(19) United States
(12) Patent Application Publication
(10) Pub. No.: US 2007/0142961 A1
(43) Pub. Date: Jun. 21, 2007

(54) System and method for providing visual aids

(75) Inventors: Vijaya Bhasin, Peoria, IL (US); Nanda Kishore Venkata Sukhavasi, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/312,485

(22) Filed: Dec. 21, 2005

(51) Int. Cl. G06F 7/00

(52) U.S. Cl. 700/216

(57) ABSTRACT

Systems and methods are disclosed that provide a visual aid for a picking operation. In one embodiment, a process is disclosed that includes capturing an image of a storage structure and associating an item to the captured image of the storage structure. The process may further include associating a task corresponding to the picking operation with the storage structure and receiving a request to provide a visual aid for the task and the storage structure. To fulfill the request for the visual aid, the process may generate the visual aid based on the image of the storage structure and then display the visual aid.

### TECHNICAL FIELD

This disclosure relates generally to visual aids, and more particularly, to a method of creating and displaying visual aids to assist human users in selecting items in a work environment.

### BACKGROUND

One routine task performed by humans in certain work environments, such as a warehouse, a factory floor, an assembly line, etc., is locating products from various storage structures to fulfill a customer order. Such manual order fulfillment processes may involve picking items, or parts, located on different storage racks and placing the selected items in a bin or conveyor belt that transports the items for shipping to a customer. These processes are typically performed by individuals known as pickers or operators in a work area.

A work area can be divided in a number of work zones. To fulfill an order or a task, receptacles, such as boxes, are typically passed from zone to zone by a roller conveyor or the like. When a receptacle is in a particular zone, an operator manually fills the order by locating the selected items within the operator's zone and placing the items into the receptacle. Alternatively, each operator can pick items from any location for placement into a receptacle located in an assembly area. One nemesis of an effective picking operation is human error in locating and replacing items used in an order fulfillment environment. Searching and replacing misplaced items consume human resources that may affect down stream processes. For example, misplaced items may hamper downstream processes such as assembling or packaging operations. Therefore, it is highly desirable to reduce human error rate in picking operations.

One effective technology used to improve the efficiency of order fulfillment systems is the “pick-to-light” system that utilizes visual light indicators functioning in combination with a display to provide order identification information. In such a system, a flashing light appears adjacent an order number in an item's location, to alert an operator as to the location and quantity of items to be placed into an order receptacle. Once the operator has removed the items from the location and placed the items into the order receptacle, the operator actuates a switch to terminate the light signal. Simultaneously, actuation of the switch is communicated to a central controller to indicate that the items have been picked and placed into the order receptacle. The controller then continues to send signals to the area to guide operators through a work area to provide visual indications as to the locations of additional items to be picked for placement into the order receptacle.

“Pick-to-light” systems not only increase picking accuracy, but also increase productivity of the order fulfillment process. However, “pick-to-light” systems are expensive to implement and maintain because, among other things, specific hardware is required for each pick location in a work area. Further, “pick-to-light” systems are difficult to reconfigure. For example, a “pick-to-light” system is generally designed to accommodate a specific configuration of its corresponding storage structure. If the configuration of the storage structure changes, the “pick-to-light” system would have to be reconfigured for the new storage structure layout. Moreover, since “pick-to-light” systems are hardware intensive, they are difficult and expensive to install and maintain. This is because installation and maintenance of “pick-to-light” systems involves installing and maintaining hardware components such as specific wiring configurations, lights, and switches, etc.

Software based systems and methods have also been developed to address the concern of human error in warehouse and assembly line operations. Typically, these solutions involve techniques for tracking and locating inventory, or items, in a warehouse or a factory floor. For example, warehouse management systems may be implemented using software applications that provide the ability to define one or more warehouse layouts and inventory locations, and manage the inventory across the defined layouts. The warehouse management system layout data may include data related to information reflecting a warehouse's master record, item/warehouse cross-reference lists, items allocated, item transfers in process, item transfer lead time, item safety stock, and fields for accumulating statistics by location. Although such systems enable a business to manage certain aspects of an order fulfillment work area, they do not provide on-location visual aids for operators performing various order fulfillment operations, such as picking operations. Therefore, there is a need for a system that creates and displays such visual aids in order fulfillment work environments.

The present disclosure improves upon the prior art systems for reducing human error in a picking operation by providing a software generated visual aid at the location of a picking operation.

### SUMMARY OF THE INVENTION

Systems and methods are disclosed that provide a visual aid for a picking operation. In one embodiment, a process is disclosed that includes capturing an image of a storage structure and associating an item to the captured image of the storage structure. The process may also include associating a task corresponding to the picking operation with the storage structure and receiving a request to provide a visual aid for the task and the storage structure. To fulfill the request, the process may generate the visual aid based on the image of the storage structure, and then display the visual aid.

In another embodiment, a visual aid system is disclosed that includes a storage unit and a computer processor. The storage unit further includes a database. The processor may be configured to collect images of storage racks with each storage rack including bins holding respective items and associate a task with a first image data of a first storage rack with a second image data of a first storage bin holding first items within the first storage bin. Further, the process may generate a visual aid for the task including the first and second image data such that a display is generated showing a real image of the first storage rack, the first bin, and first items along with an instruction corresponding to the task.

The disclosed systems and methods may be implemented in work environments for various picking, kitting, and assembly operations.

### BRIEF DESCRIPTION OF THE DRAWINGS

FIG. 1 illustrates a block diagram of an exemplary system consistent with certain disclosed embodiments;

FIG. 2 illustrates a diagram of an exemplary picking operation consistent with certain disclosed embodiments;

FIG. 3 illustrates a diagram of an exemplary visual aid consistent with certain disclosed embodiments;

FIG. 4 illustrates a flowchart of an exemplary process to generate visual aids consistent with certain disclosed embodiments;

FIG. 5 illustrates a block diagram of an exemplary database system consistent with certain disclosed embodiments; and

FIG. 6 illustrates a diagram of exemplary images of storage bins consistent with certain disclosed embodiments.

### DETAILED DESCRIPTION

Reference will now be made in detail to embodiments of the invention, examples of which are illustrated in the accompanying drawings. Wherever possible, the same reference numbers will be used throughout the drawings to refer to the same or like items.

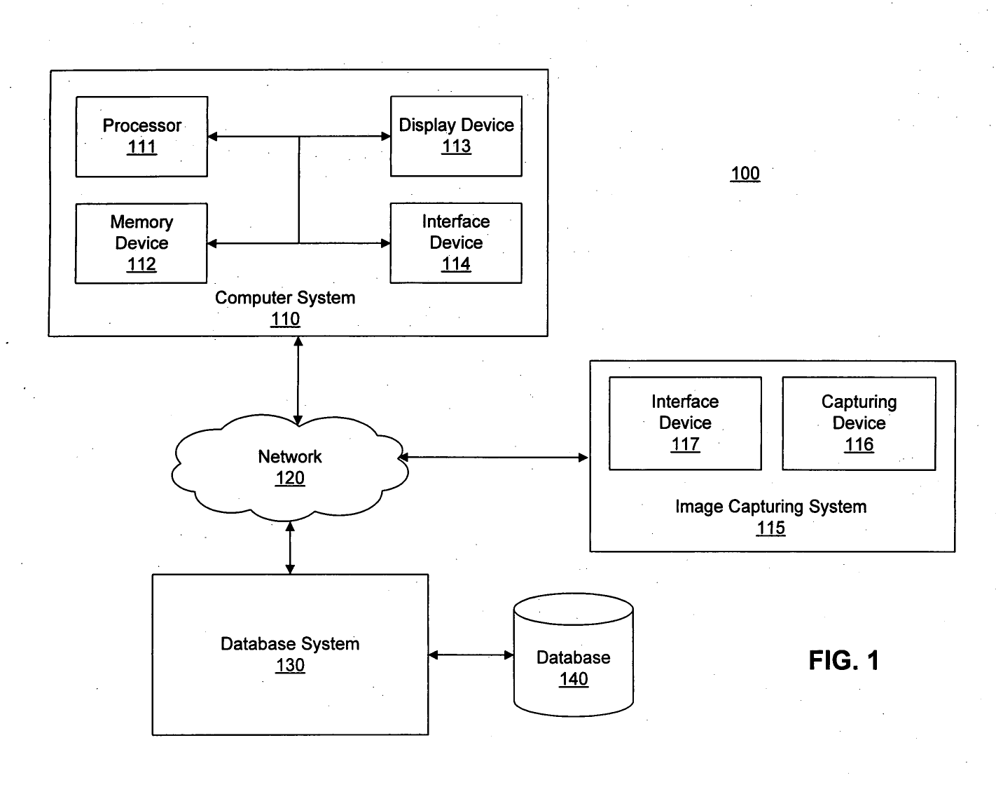

FIG. 1 illustrates a system environment 100 with features and principles consistent with an exemplary disclosed embodiment. As shown in FIG. 1, this system 100 may include a computer system 110, an image capturing system 115, a network 120, and a database system 130.

Computer system 110 may be a computing system, such as a laptop computer, desktop computer, workstation, mainframe, etc., that is operated by a user. Computer system 110 may include, for example, a processor 111, a memory device 112, a display device 113, and an interface device 114. Processor 111 may be one or more processor devices, such as a microprocessor, that execute program instructions to perform various functions. Memory device 112 may be one or more storage devices that maintain data (e.g., instructions, software applications, etc.) used by processor 111. For example, memory device 112 may include a software application that enables computer system 110 to retrieve content from external sources, such as a remote database system. Memory device 112 may also include software that performs, when executed by processor 111, processes for creating and displaying visual aids consistent with certain embodiments disclosed below. Additionally, memory device 112 may include software that performs processes, when executed by processor 111, that collaborate with another computer system to perform processes for creating and displaying visual aids consistent with certain disclosed embodiments. Display device 113 may be any known type of display device that presents information to a user of computer system 110. Interface device 114 may be one or more known interface modules that facilitate the exchange of data between the internal components of computer system 110 and external components, such as database system 130. Further, interface device 114 may include a network interface device that allows user system to receive and send data to and from network 120.

Image capturing system 115 may be any type of computer system that executes software for capturing image data used by computer system 110 to create visual aids, and transferring the captured image data between different system components. Image capturing system 115 may include a capturing device 116 and an interface device 117. Capturing device 116 may be a digital camera, a digital scanner, or any other type of device that may be used to capture images in a digital format, although other formats are also contemplated. Interface device 117 may be one or more known interface modules that manage the exchange of data between the internal components of image capturing system 115 and external components, such as database system 130. To this end, interface device 117 may include a network interface device (not shown) that receives and sends data from and to network 120.

Network 120 may be any type of network that facilitates communications between remote components. For example, network 120 may be a local area network (LAN), a wide area network (WAN), a dedicated intranet, the Internet, and/or a wireless network. Network 120 may be implemented using wired or wireless communication mediums or a combination of both. Further, network 120 may represent a communication path that interfaces components within a single computing environment, such as computer system 110, image capturing system 115, and database system 130. In one embodiment, system environment 100 may represent a single computing system. Alternatively, system environment 100 may be a distributed system.

Database system 130 may represent one or more storage devices configured in any type of known storage system configuration that stores data. Database system 130 may include processing components that locate, refer, and retrieve the data stored in storage devices, (e.g., Sybase, Oracle, MySQL, SQL, Access, etc.). In one exemplary embodiment, database system 130 interfaces with, or includes, database 140 that may store data that may be received from computer system 110 and image capturing system 115, and may be retrieved and processed by computer system 110. Database 140 may be one or more storage devices that store information, such as a CD-ROM, a DVD, a floppy disk, a hard disk, a flash memory device, a magnetic card, a tape drive, an array of memory devices, etc. Database 140 may include data structures that are configured in a searchable format. Database 140 may include more complex data structures, such as a Relational Database Management System (RDBMS). The data structures may be created using known or specialized database software. In one embodiment, database system 130 may execute the specialized database software to search database 140 based on search queries written in any type of database program languages, such as Structured Query Language (SQL).

In an exemplary embodiment, database 140 may store order fulfillment information (e.g., text, number, or image data etc.) associated with an order fulfillment system. This information may include data association with assembly line operations of tasks, storage rack layouts, items, etc.

A storage rack may be a physical storage structure that supports one of more bins used to hold items. An item may be any type of product associated with the order fulfillment system, such as a part for a machine, computer, etc., and any other type of product that may be produced by a business entity associated with the order fulfillment system. Storage rack layout refers to the physical configuration of the storage rack, i.e. how the rack is partitioned to hold storage bins or items.

Database 140 may configure assembly operation data based on an assembly operation identification key that corresponds to one or more tasks. An assembly operation may constitute multiple tasks or orders. Assembly operation data may include all data related to the definition and processes of assembly operations. Database 140 may configure task data based on a task identification key that corresponds to one or more items needed to fulfill a given task. Task data may include all data related to the definition and processes of tasks. Database 140 may configure item data based on identification keys associated with storage racks and storage bins that store items. Item data may include all data related to the definition and processes of items. Database 140 may also configure image data associated with storage racks and storage bins based on their respective identification keys. Image data may include all data related to the definition and processes of storage structure images. Database 140 may be configured to store data to associate items, storage racks, tasks, and assembly operations that is used by computer system 110 to generate and display a visual aid consistent with certain disclosed embodiments.

System environment 100 may be implemented in different configurations. For example, computing system 110 and database system 130 may be directly connected within a single computing environment. Additionally, computing system 110 may be included within database system 130, or vice versa, thus allowing database system 130 to receive an internal request from a user operating computer system 110. Further, additional components may be included in system environment 100, such as one or more additional database systems or display devices that may exchange information with each other and computing system 110. As such, the configuration of system environment 100 shown in FIG. 1 is not intended to be limited to the disclosed environment.

In one embodiment of the invention, exemplary system environment 100 may be configured to create and display a visual aid requested by a user operating computer system 110. A user request for a visual aid is associated with a specific task and a specific storage rack, although the type of request and the information obtained from the request may vary. For example, one or more visual aids may be requested by a software process executed by computer system 110.

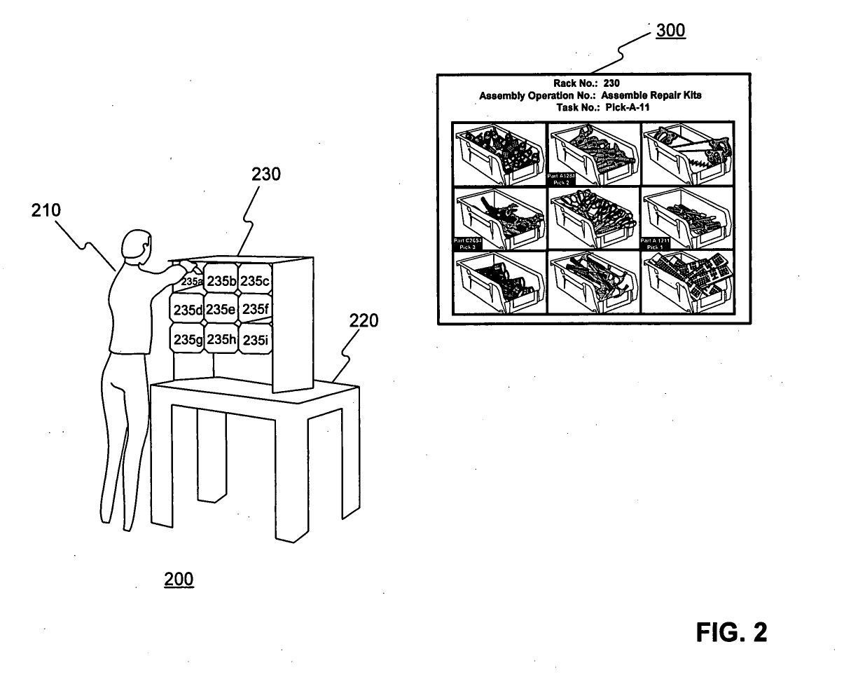

FIG. 2 illustrates a block diagram reflecting an exemplary picking operation environment 200 employing visual aid 300 consistent with certain disclosed embodiments. A picking operation may involve picking multiple items from multiple racks. FIG. 2 may also illustrate a kitting or an assembly operation environment employing visual aid 300 consistent with certain disclosed embodiments. A kitting operation may tasks associated with preparing an order for shipment. For example, a kitting operation may include simple assembly tasks, picking and packing of order items into a “kit,” and completing set of items to be shipped. Another operation often involving picking items is an assembly operation. An assembly operation may include picking items, such as a specific number of certain nuts and bolts, for performing an assembly or manufacturing task.

As shown in FIG. 2, a picking operation environment 200 may include a storage rack 230, storage bins 235a-i, a picking station 220, and a visual aid 300. A picking operation may be performed within environment 200 by operator 210 (i.e., picker) in a warehouse or a factory floor. In performing a picking operation, operator 210 may verify an assigned task number on visual aid 300 (e.g., “Pick-A-11”). Operator 210 may read instructions from visual aid 300 to determine the identity and quantity of items to be picked to complete the assigned task “Pick-A-11.”

Picking station 220 may be any type of work surface including receptacles used to fulfill a picking operation of multiple items. Picking station 220 may include any type of assembly station, or manufacturing work surface. Picking station 220 may be mobile, so that it may be moved to different work locations in a work area. For example, picking station 220 may be a part of an assembly line, a factory floor, etc.

Storage rack 230 may be a mobile or a fixed storage structure for storing items. As disclosed herein, a storage structure may reflect one or more storage racks. Storage rack 230 may hold several storage bins (e.g., 235a-i). Depending on the design of a storage rack, the number of storage bins stored on a rack may vary. Each storage bin (e.g., bin 235a), may have a front label (not shown) that includes a code identifying information such as the item number, type, and quantity of the item stored in the given storage bin (e.g. bin 235a).

Visual aid 300 may be any type of visual image display created by computer system 110. Visual aid 300 may be presented on one or more display devices. For example, visual aid 300 may be presented on a touch-screen display device to allow exchange of information between operator 210 and computer system 110. In one embodiment of the invention, visual aid 300 may be positioned within a determined vicinity of rack 230 to assist operator 210 in completing an assigned picking operation. In another embodiment of the invention, visual aid 300 may be presented on a display device attached to picking station 220. Visual aid 300 may display any type of information associated with a picking operation, such as assembly operation identification, task identification, and storage rack identification information. For example, visual aid 300 may display content such as assembly operation “Assemble Repair Kits,” task “Pick-A-11,” and rack number “230.” Visual aid 300 may display image data associated with picking operation environment 200, such as a three dimensional image of storage rack 230 and storage bins 235a-i, including the items stored in storage bins 235a-i. Further, visual aid 300 may identify the items, and quantities of the items to be picked from rack 230. For example, visual aid 300 may indicate that operator 210 should pick three items labeled item C2654, from storage bin 235d.

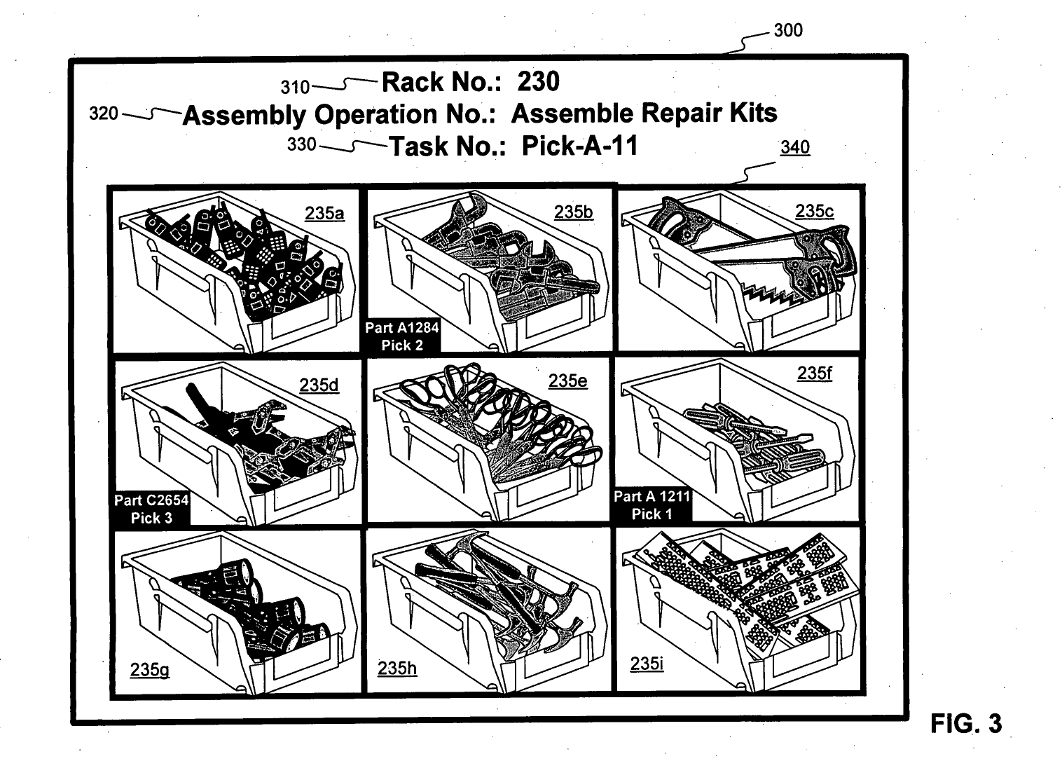

FIG. 3 illustrates an enlarged diagram of visual aid 300. Visual aid 300 may present a rack number 310, an assembly operation number 320, a task number 330, and an image 340 of storage rack 230. In one exemplary embodiment, visual aid 300 may indicate that assembly operation “Assemble Repair Kits” includes task “Pick-A-11.” Visual aid 300 may also present content reflecting that task “Pick-A-11” requires selecting items A1284, C2654, and A1211 from rack 230. Visual aid 300 may further present content reflecting that task “Pick-A-11” includes certain quantities of the items to be picked, such as two of part A1284 from storage bin 235b, three of part C2654 from storage bin 235d, and one of part A1211 from storage bin 235f of rack 230. By following directions from visual aid 300, operator 210 may complete a picking operation on rack 230 for task “Pick-A-11.”

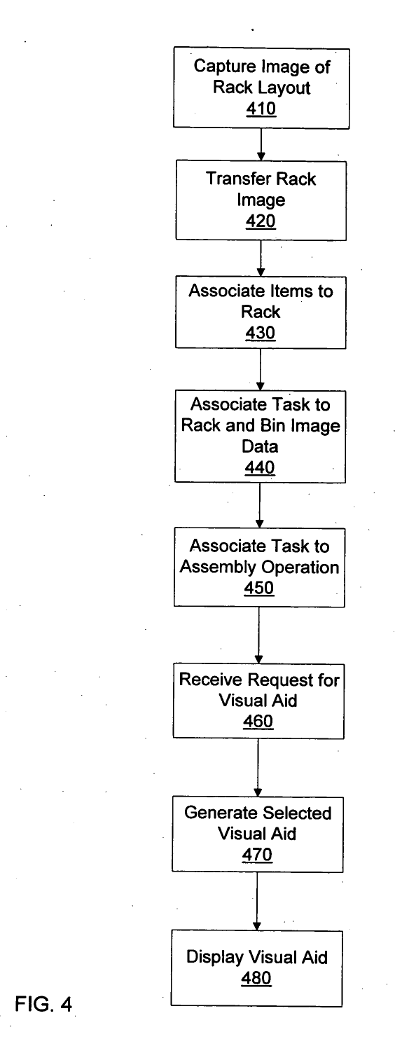

FIG. 4 provides a flow chart of a visual aid creation process for a part picking operation consistent with certain disclosed embodiments. In one exemplary embodiment, the visual aid creation process may be performed by a software application executed by computer system 110. The process may begin with capturing an image of storage rack layout (step 410). Storage rack layout refers to the partition of the storage rack, i.e. how the rack is partitioned to hold storage bins or items. This may include a user who operates image capturing system 115 and capturing device 116 to capture digital image of a storage rack (e.g., 230). The captured image may be a three dimensional image of the storage rack. The captured image may also include images of storage bins 235a-i, and the items stored in storage bins 235a-i of rack 230. For example, a user may use an image capturing device such as a digital camera to take digital photos of rack 230 and storage bins 235a-i.

The process of capturing an image of a rack layout may also involve a user capturing data that defines the layout of the storage rack, such as the configuration of storage bins 235a-i. In one embodiment, the layout of storage rack 230 may be defined by certain industry standards. In another embodiment, a software application executed by processor 111 may provide an interface that allows a user to enter the dimensions of a storage rack (e.g., 230) and the dimensions of its storage bins (e.g., 235a-i). The software application may be an inventory tracking system combined with a graphical drawing engine. In this embodiment, the user may draw the layout of the storage rack with the measured dimensions. Alternatively, the user may select a storage rack layout from a library of rack types and layouts shown in a memory device with display to the user via computer system 110 or image capturing system 115. The user may also generate storage rack layouts corresponding to the real measurements of a captured storage rack and storage bins to form a storage rack layout data record. The rack layout data record may include the identification of the corresponding storage rack and storage bins. A software application executed by processor 111 may use this identification data to associate the captured images of storage racks and bins to their corresponding layout data for creating visual aids. The application may export the rack layout data to other software applications executed by a processor, such as MS Excel, a CAD application, etc.

Next, image capturing system 115 may transfer captured images of the storage rack and storage bins with the corresponding rack and storage bin identification data to database system 130 through network 120 (Step 420). Image capturing system 115 or computer system 110 may also transfer the storage rack layout data for the storage rack to database system 130. The layout and images of the storage rack and storage bins may then be saved in database 140 for further processing.

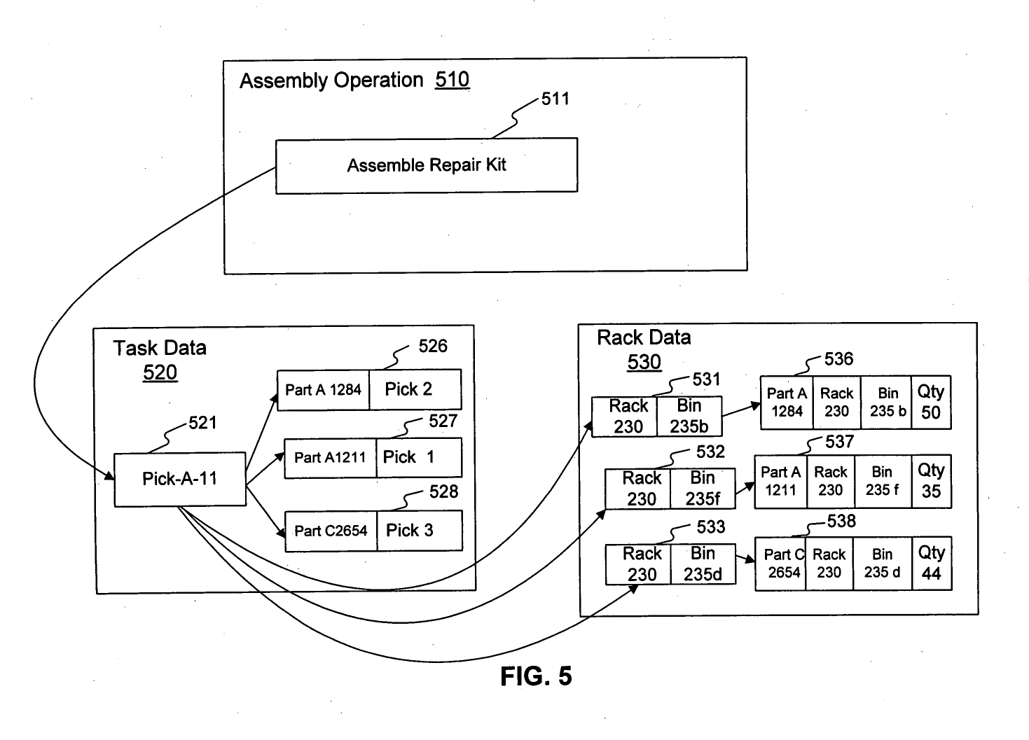

To better illustrate certain exemplary embodiments, FIG. 5 shows a block diagram of exemplary data structures of information that may be stored in database 140 consistent with certain disclosed embodiments. As shown, database 140 may store an assembly operation data portion 510, task data portion 520, and rack data portion 530. Operation data portion 510 may includes data related to assembly operations, such as data for identification, description, and tasks of an assembly operation. Task data portion 520 may include data that identifies a task, and items and actions required by the task. Rack data portion 530 may include data for storage rack identification, storage rack and storage bin images, items, and quantities of items stored in storage bins. Assembly operation portion 510, task data portion 520 and rack data portion 530 may be implemented using one or more database tables or data files.

Returning back to FIG. 4, after images of the storage rack and its storage bins are transferred to database system 130, computer system 110 may associate stored items with corresponding storage rack and storage bin images (Step 430). In one embodiment, database 140 may contain data indicating the quantities of items stored in each storage bin of each storage rack. When image capturing system 115 transfers an image of a storage rack to database system 130, it may send a message to computer system 110, triggering a search in database 140 to locate item data for the items stored on a given storage rack. For example, as shown in FIG. 5, rack data 520 stored in database 140 may include item data 536 indicating 50 of part A1284 are stored in storage bin 235a of rack 230. When image capturing system 115 transfers image data 531 of storage bin 235a to database system 130, computer system 110, in response to a notification message, may search database 140 to locate the item data related to rack 230, such as item data 536. Similarly, computer system 110 may search database 140 to locate item data 537 and 538 for other rack data related to a given storage rack.

Computer system 110 may also associate items to image data for given storages bins. For instance, referring to FIG. 5, computer system 110 may associate item data 536, 537, and 538 of items A1284, A1211, and C2654 to image data 531, 532, and 533 for storage bins 235b, 235f, and 235d respectively.

To establish data associations, computer system 110 may utilize data associations defined in database 140, which may be defined by using any type of data structure that establishes a logical link between data elements, such as item data 536 and image data 531. For example, the disclosed embodiment may use a relational database including logical links represented by primary key and foreign key relationships in database tables. For instance, a database user may define the rack identification, “Rack 230,” as the primary key of an image data table which may contain data 531, 532, 533 as three rows in the table. The user may further define the rack identification, “Rack 230,” as a foreign key of a item data table which may contain data 536, 537, 538 as three rows. The foreign key in the item data table, “Rack 230,” may then refer to the primary key of the image data table. This reference may establish the logical link, i.e. the association, between the two sets of data elements. Other forms of relationships between data stored in database 140 may be implemented, and the above examples are not intended to be limiting.

In one embodiment of the invention, computer system 110 may associate data in database 140 according to a predetermined schedule. Alternatively, computer system 110 may associate data based upon a request from a user of computer system 110 and/or database system 130.

Computer system 110 may associate a task to storage rack image data and storage bin image data (Step 440). A picking operation may constitute picking multiple items from multiple racks. A task may constitute multiple picking operations from various storage racks. An exemplary task may be building a specialty tool kit of multiple small tools. For example, task 521 “Pick-A-11” stored in database 140 may contain detailed task data 526, 527, and 528, designating a particular picking operation (e.g., pick two of part A1284, pick three of part C2654, and pick one of part A1211). In this example, computer system 110 may search for item data 536, 537 and 538 in rack data portion 530 of database 140 for items A1284, C2654, and A1211. After locating item data 536, 537 and 538, computer system 110 may identify storage bins 235b, 235f, and 235d of rack 230, from which items A1284, C2654, and A1211 can be picked by an operator. Computer system 110 may then search for image data 531, 532, and 533 of storage bins 235b, 235f, and 235d of rack 230. Computer system 110 may then associate task 521 “Pick-A-11” to rack and storage bin image data 531, 532 and 533. Computer system 110 may associate a task with rack and/or storage bin image data based on a predetermined schedule and/or in response to a request from another system and/or a user of computer system 110.

Computer system 110 may also associate a task to an assembly operation (Step 450). An assembly operation may constitute multiple tasks. In one embodiment, data in database 140 may indicate that assembly operation 511 “Assemble Repair Kit” includes task 521 “Pick-A-11.” Computer system 110 may therefore associate task 521 “Pick-A-11” to assembly operation 511 “Assemble Repair Kit.” Computer system 110 may associate a task to an assembly operation based on a predetermined schedule, or in response to a request from another system, or a request from a user of computer system 110.

At some point during a picking operation, a user of computer system 110 may enter a storage rack identification, a task identification, and/or an assembly operation identification through interface device 114 to request a visual aid for the picking operation (Step 460). For example, a user may request a visual aid for task 521 “Pick-A-11” and storage rack 230. Alternatively, a user may only select task 521 without select a specific storage rack when requesting a visual aid. Computer system 110 may provide the user with a list of storage racks associated with task 521. The user may then select rack 230 from the list of presented storage racks associated with task 521.

Computer system 110 may generate a visual aid in one embodiment according to the received user request (Step 470). In one embodiment, upon receiving the request for task 521 and storage rack 230, computer system 110 may search database 140 for image data associated with storage bins 235a-i of requested rack 230. Computer system 110 may also identify all storage bins, 235b, 235d, and 235f, associated with the task identified with the request, such as task 521 “Pick-A-11.” For example as shown in FIG. 5, image data 531 of bin 235b is associated with task 521. Computer system 110 may search item data 536 of storage bin 235b for an associated item A1284. In turn, for item A1284, computer system 110 may then search database 140 for an action and quantity defined in task data 526. Computer system 110 may then use the retrieved task data 526 to generate an instruction that includes the identification of the item, the action to be taken for the operation, and the quantity specified for the operation. For example, for operation data 526, computer system 110 may compose instruction “Part A1284—Pick 2.” Computer system 110 then may overlay the composed instruction, “Part A1284—Pick 2,” on the associated image file 531 to indicate the quantity of items need to be picked from bin 235b. Computer system 110 may repeat this step, to overlay instructions on image data 532 and 533 of storage bins 235f and 235d, associated with task 521 on rack 230.

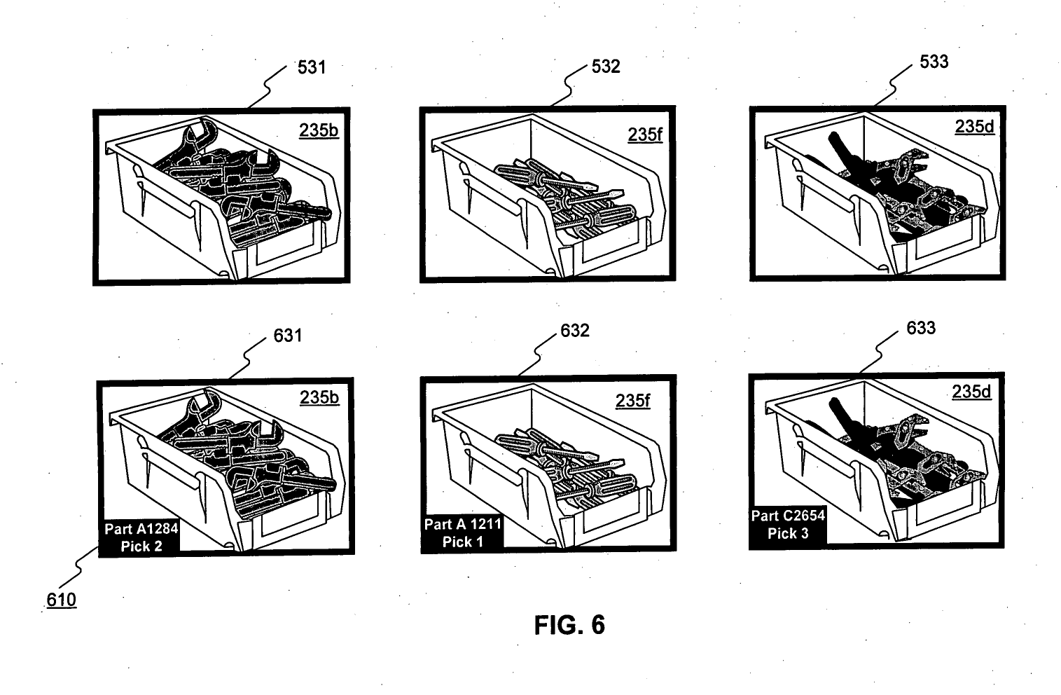

To further describe this exemplary embodiment, FIG. 6 shows exemplary images of storage bins 235b, 235f, and 235d. As described above, in one disclosed embodiment, computer system 110 may identify image 531 of storage bin 235b as being associated with task 521. Based on this association, computer system 110 may compose an instruction 610 by resolving the data associations of the requested task and storage rack. Thereafter, computer system 110 may overlay instruction 610 on the original image file 531 to create a modified storage bin image 631. Computer system 110 may repeat this process for storage bins 235d and 235f, which are also associated with task 521, on rack 230. Modified images 632 and 633 may then be created for storage bin 235f and 235d.

Computer system 110 may also compose and display the generated visual aid 300 (Step 480). In one embodiment, computer system 110 may arrange all storage bin images for a given rack in a predetermined layout for display. For example, computer system 110 may use the modified images 631, 632, and 633 of storage bins 235b, 235d, and 235f of task 521 for generating the visual aid. Storage bins 235a, 235c, 235e, 235g-i are not associated with task 521, as such, computer system 110 may use the unmodified (e.g., original capture) images for display. Using the rack 230 layout data in database 140, computer system 110 may re-arrange the images of storage bins. Thus, visual aid 300 may include specific picking instructions on real images of storage bins 235b, 235d, and 235f of rack 230. Visual aid 300 may display the images without instructions for storage bins not associated with the task, such as 235a, 235c, 235e, 235g-i. Computer system 110 may also provide the identification information for assembly operation 511, task 521, and rack 230 on the display of visual aid 300. Computer system 110 may display visual aids on various display devices.

### INDUSTRIAL APPLICABILITY

Methods and systems consistent with the disclosed embodiment provide visual aid assistance in order fulfillment work environments. The disclosed visual aid system is adaptive to re-configurations of a storage space or an assembly line, thus providing benefits over typical “pick-to-light” systems. Further, the disclosed visual aid system is adaptable to new work environment configurations. Also, the disclosed visual aid system is adaptable for installation in new work environments. For example, to deploy the disclosed visual aid system in a new warehouse, only software applications need be installed and database 140 information be configured.

The disclosed visual aid system is applicable for use in work environments to reduce human error. The real image based, instructive visual aids provided by the disclosed embodiments may reduce the amount of time needed to train a new picker or operator. The disclosed visual aid can also reduce human error during picking operations. Thus, the on-location visual aid system also provides instructions to operators who otherwise would have more difficulty identifying and picking the correct items. The disclosed visual aid offers a mechanism to reduce the number of errors made by operators while performing a task.

Errors made in picking operations can cause loss in time and confusion in multiple downstream processes. As such, by reducing human error in picking operations, the disclosed visual aid system can improve the overall production quality. Further, downstream operations, such as packaging and assembling, depend on picking operations to provide the correct items.

The disclosed visual aid system may be implemented in various work environments, including work environments for picking, kitting, and assembly operations. For example, the disclosed visual aid system may provide instructions to an assembly line worker at an assembly or manufacturing station regarding quantities of items to obtain (e.g., certain numbers of specific bolts, and nuts from specific bins), to perform an assembly or manufacturing task.

The disclosed visual aid system may also improve the operating efficiency of an inventory management system. To optimize the use of floor space, inventory transit time, and human resources, modern logistics planning often schedules inventory movements and plans for storage spaces very precisely. Operation errors can cause delays in inventory movements and sub-optimal use of floor space. By reducing error rate in picking operations, the disclosed embodiments help achieve overall optimization of inventory and storage space management.

It will be apparent to those skilled in the art that various modifications and variations can be made in the disclosed armature assembly without departing from the scope of the disclosure. Additionally, other embodiments of the disclosed system will be apparent to those skilled in the art from consideration of the specification. It is intended that the specification and examples be considered as exemplary only, with a true scope of the disclosure being indicated by the following claims and their equivalents.

What is claimed is:

1. A method for providing a visual aid for a picking operation, comprising:
capturing an image of a storage structure;
associating an item to the captured image of the storage structure;
associating a task corresponding to the picking operation with the storage structure;
receiving a request to provide a visual aid for the task and the storage structure;
generating the visual aid based on the image of the storage structure; and
displaying the visual aid.

2. The method of claim 1, wherein capturing the image of the storage structure includes capturing a physical layout of the storage structure.

3. The method of claim 1, wherein associating the task to the storage structure includes locating an item associated with the task, locating the storage structure holding the item, and locating the captured image of the storage structure based on the association between the item and the task.

4. The method of claim 1, wherein receiving a request to provide the visual aid for the task and the storage structure includes receiving identification of the task and the storage structure.

5. The method of claim 1, wherein generating the visual aid includes modifying the captured image of the storage structure, and generating the visual aid based on the modification.

6. The method of claim 5, wherein modifying the captured image includes overlaying an operation instruction on the identified image.

7. The method of claim 6, wherein the operation instruction includes data identifying a quantity of the item to be picked from the storage structure.

8. A visual aid system comprising:
a storage unit including a database; and
a processor configured to:
collect images of storage racks, each storage rack including bins holding respective items,
associate a task with a first image data of a first storage rack with a second image data of a first storage bin holding first items within the first storage bin, and
generate a visual aid for the task including the first and second image data such that a display is generated showing a real image of the first storage rack, the first bin, and first items along with an instruction corresponding to the task.

9. The system of claim 8, wherein the processor is configured to capture images of a storage rack including capturing a physical layout of a storage rack.

10. The system of claim 8, wherein the processor is configured to locate an item associated with the task, locate the storage rack holding the item, and locate the captured image of the storage rack based on the association between the item and the task.

11. The system of claim 8, wherein the processor is configured to receive a request to provide a visual aid for a task or a storage rack.

12. The system of claim 8, wherein the processor is configured to modify the second image of the first storage bin and generate the visual aid based on the modification.

13. The system of claim 12, wherein the processor is configured to modify the second image by overlaying an operation instruction on the second image.

14. The system of claim 13, wherein the operation instruction includes data identifying a quantity of the item to be picked from the first storage bin.

15. A system for providing a visual aid for a picking operation, comprising:
means for capturing an image of a storage structure;
means for associating an item to the captured image of the storage structure;
means for associating a task corresponding to the picking operation with the storage structure;
means for receiving a request to provide a visual aid for the task and the storage structure;
means for generating the visual aid based on the image of the storage structure; and
means for displaying the visual aid.

16. The system of claim 15, wherein the means for capturing the image of the storage structure includes means for capturing a physical layout of the storage structure.

17. The system of claim 15, wherein the means for associating the task to the storage structure includes means for locating an item associated with the task, means for locating the storage structure holding the item, and means for locating the captured image of the storage structure based on the association between the item and the task.

18. The system of claim 15, wherein the means for receiving the request to provide a visual aid for the task and the storage structure includes means for receiving identification of the task and the storage structure.

19. The system of claim 15, wherein the means for generating the visual aid includes means for modifying the captured image of the storage structure, and means for generating the visual aid based on the modification.

20. The system of claim 19, wherein the means for modifying the captured image includes means for overlaying an operation instruction on the identified image.

21. The system of claim 20, wherein the operation instruction includes data identifying a quantity of the item to be picked from the storage structure.
